(19) United States
(12) Patent Application Publication
(10) Pub. No.: US 2003/0013777 A1
(43) Pub. Date: Jan. 16, 2003

(54) Closed-cell thermosetting plastic foams & methods of producing thereof using acetone and water as blowing agents

(76) Inventors: James Thornsberry, Meridian, MS (US); Gregory Islas, Meridian, MS (US); Robert H. Blanpied, Meridian, MS (US)

Correspondence Address: NIXON & VANDERHYE P.C., 8th Floor, 1100 North Glebe Road, Arlington, VA, 22201, US

(21) Appl. No.: 10/135,829

(22) Filed: May 1, 2002

Related U.S. Application Data
(60) Provisional application No. 60/287,388, filed on May 1, 2001.

(51) Int. Cl. C08J 9/00; C08K 3/00

(52) U.S. Cl. 521/131

(57) ABSTRACT

Rigid closed cell polyisocyanate-based insulation foams are created by reacting at least one organic polyisocyanate with compounds having at least two active hydrogen atoms in the presence of acetone used as an expansion, or blowing, agent. Various additives common to rigid closed-cell foam such as cell size controlling silicone surfactants are used to produce a thermal insulating rigid foam. Also, catalysts, flame retardant chemicals, and organic surfactants can be any of the ordinary products normally used by those experienced in the art of foam production. The utilization of acetone and water reduce the amount of hydrocarbon VOCs needed to obtain any given density thus reducing the volatile organic compounds released from the foam insulation. This benefit comes without detriment to the other important qualities needed in such a foam.

This application claims the priority and benefit of U.S. Provisional Patent Application Serial No. 60/287,388, filed May 1, 2001, which is incorporated herein by reference in its entirety.

### BACKGROUND

I. Field of the Invention

The present invention pertains to rigid closed-cell insulative thermosetting foam products and methods of making said products.

II. Related Art and Other Considerations

Cellular organic plastic foams used for thermal insulation are well known in the art. Such foams can be made with urethane linkages, or made with a combination of both isocyanurate linkages and urethane linkages, or they can be made via the well know condensation reactions of formaldehyde with phenol, urea, and melamine. All such plastic foams must utilize an expansion agent, often referred to as a “blowing agent”. Much has been written regarding the improvement of insulation values via utilization of unique blowing agents, or combinations of blowing agents. Several other methods to improve insulation values include better surfactants or other improved chemicals. Other additives can improve the facer adhesion.

Most of the rigid foam insulation presently manufactured is utilized the building construction trade. To meet building codes and building insurance requirements, flame retardant materials are often added to these foams. Hydrocarbon, or other VOC (Volatile Organic Compound) blown foams require expensive Flame Retardant (FR) additives. These additives are usually organic halogens or phosphates, or combinations of organic halogens with phosphate included.

The prior art is replete with references to techniques of expanding thermosetting foams to give them better insulative value, or improve their physical strength or other properties. In recent years, all of these methods and the products thereof have been taught in such United States patents as the following (all of which are incorporated herein by reference) U.S. Patent Numbers:

| | | | |
|---|---|---|---|
| 3,558,531 | 3,993,609 | 4,636,529 | 4,898,893 |
| 4,927,863 | 4,931,119 | 4,972,003 | 4,981,876 |
| 4,981,880 | 4,986,930 | 4,996,242 | 5,032,623 |
| 5,034,424 | 5,057,547 | 5,070,113 | 5,093,377 |
| 5,096,933 | 5,102,919 | 5,102,920 | 5,114,985 |
| 5,114,986 | 5,120,771 | 5,130,345 | 5,164,419 |
| 5,166,182 | 5,169,873 | 5,182,309 | 5,205,956 |
| 5,213,707 | 5,227,088 | 5,234,967 | 5,236,611 |
| 5,248,433 | 5,254,601 | 5,262,077 | 5,272,183 |
| 5,277,834 | 5,278,196 | 5,283,003 | 5,290,823 |
| 5,296,516 | 5,304,320 | 5,314,926 | 5,318,996 |
| 5,336,696 | 5,367,000 | 5,426,127 | 5,444,101 |
| 5,461,084 | 5,519,065 | 5,578,651 | 5,578,652 |
| 5,601,753 | 5,624,969 | 5,631,305 | 5,665,788 |
| 5,723,509 | 5,741,825 | 5,840,212 | 5,847,018 |
| 5,866,626 | 5,889,066 | 5,907,014 | 5,962,542 |
| 6,207,725 | 6,358,908 | | |

For many years, the dominant blowing agent used to expand thermosetting plastics into cellular foam for use as insulation was trichlorofluoromethane (CFC-11). This product had all the characteristics needed for foam insulation, but was determined to be a threat to stratospheric ozone. After trichlorofluoromethane (and all the “CFCs”) was phased out, the most common class of blowing agents became the hydrogenated chlorofluorocarbons (called “HCFCs”). These products are considered to be somewhat environmentally friendly expansion agents, but still contain some chlorine. However, the chlorine atoms of HCFCs are stable at altitudes under the stratosphere, so therefore they have a lower “Ozone Depleting Potential” (called “ODP”). But because they do have even a small ODP, the HCFCs have also been mandated for eventual phase out.

There is one chlorine containing molecule that the US EPA has approved for use as a blowing agent. This organic chloride is 2-chloropropane, CH₃—CHCl—CH₃. This substance is listed by the Environmental Defense Fund's (EDF's) Scorecard as a suspected health hazard. Prior art foam technology using 2-chloropropane as a blowing agent includes U.S. Pat. Nos. 5,064,872; 5,132,332; 5,468,420; and 5,523,333.

Another known class of blowing agents useful as a co-expansion agent is the non-chlorinated, partially hydrogenated fluorocarbons (called “HFCs”) which have the general formula: HₓF_{y}C_{z} where x, y, and z are integers. The HFC compounds that have been approved for use as future expansion agents are HFC-134a, HFC-152a, and HFC-245fa. Some of these three compounds are now being utilized by either the aerosol industry or the refrigeration industry. This utilization factor has reduced the cost of these compounds whereby it may be affordable to use them as a portion, but not all, of the total blowing agent package. In view of the fact that about ten percent by weight of rigid foam insulation can be the compounds used as blowing agents, the still relatively high cost of HFCs needs to be offset by other, lower cost, expansion agents.

Another category of organic blowing agents under industry scrutiny are mixtures of (1) 1,3-dioxolane with either cyclopentane or an isomer of hexane (as taught in U.S. Pat. No. 6,358,908); and (2) dimethoxymethane with cyclopentane alone, or with cyclopentane and 2-methyl pentane (as taught in U.S. Pat. Nos. 5,631,305; 5,665,788; and 5,723,509).

In the mid-1990s, the industry began looking at hydrocarbons as expansion agents, even though most of the governments in the United States of America were restricting Volatile Organic Compound (VOC) emissions. Pure cyclopentane is the only isomer of pentanes that is quite soluble in polyurethane compounds. Therefore, the advent of highly efficient thermal insulation foams came in the form of expansion agents made of essentially pure cyclopentane. U.S. Pat No. 5,578,652 and its various continuations taught this new art which insured the future of rigid polyurethane foam insulation for building construction. This technology was successful for many years. However, the cost of 98% pure cyclopentane remained high, causing insulation manufacturers to look at other options. Among those options were various mixtures of low purity cyclopentane, including mixtures with n-pentane and isopentane. The latter two isomers of pentane have very poor solubility in ordinary polyurethane compounds. So while this technology had cost benefits, it was discovered that because both normal- and isopentanes were not soluble in polyurethane polymer mixes, the emissions of VOCs could be very high. The use of n-pentane or isopentane required that an emulsion be created with the polyol and other B-Side components. Apparently, the emulsion form did not hold the hydrocarbons in the foaming compounds during manufacture.

The use of acetone as a blowing agent is cited often throughout the history of thermosetting foams. It has been casually referenced many times for possible use as an expansion agent in rigid closed-cell thermal insulation foam. However, apparently it has never been successfully used commercially in rigid closed-cell thermal insulation foam. In commercial manufacturing, the use of acetone as a blowing agent has been limited to thermoplastic polystyrene foam, or thermosetting flexible polyurethane foam and integral skin polyurethane foam.

U.S. Pat. Nos. 5,939,463 and 6,136,875 mention acetone as a useful blowing agent in sheets of foamed polystyrene (thermoplastic) foam.

U.S. Pat. No. 5,120,771 to Walmsley, teaches the use of acetone as a blowing agent in flexible polyurethane foam.

A partial list of references where acetone is generally touted as a potential blowing agent for rigid polyurethane foam includes the following U.S. Patent Numbers (all of which are incorporated herein in their entirety by reference):

| | | | |
|---|---|---|---|
| 3,558,531 | 5,013,766 | 5,102,923 | 5,109,031 |
| 5,166,182 | 5,194,325 | 5,200,435 | 5,268,393 |
| 5,278,195 | 5,300,534 | 5,336,696 | 5,373,030 |
| 5,416,130 | 5,512,602 | 5,523,334 | 5,525,641 |
| 5,547,998 | 5,578,652 | 5,654,344 | 5,684,057 |
| 5,741,825 | 5,760,099 | 5,770,635 | 5,786,401 |
| 5,801,210 | 5,807,903 | 5,847,018 | 5,866,626 |
| 5,883,146 | 5,908,871 | 6,011,189 | 6,013,690 |
| 6,031,013 | 6,040,375 | 6,046,247 | 6,066,681 |
| 6,166,109 | 6,191,179 | 6,207,725 | 6,211,257 |

Yet, only two of the patents above describe actual examples of using acetone as a blowing agent in rigid foam. U.S. Pat. No. 3,558,531 shows up to 40% by volume of acetone with cyclopentane using a multifunctional polyether polyol to make unmodified polyurethane foam. U.S. Pat. No. 5,336,696 shows Example 7 where acetone was used with cyclopentane to make unacceptable foams having cracks.

Some foreign patents briefly mention acetone as a blowing agent. These include

| | | | |
|---|---|---|---|
| JP 62022833A2 | JP 2284932A2 | JP 2173131A2 | JP 4306243A2 |
| JP 7316335A2 | JP 10087926A2 | WO 056809A1 | |

As of April 2001, the US Environmental Protection Agency (EA) had added acetone to the Significant New Use Program (SNAP) as a blowing agent only for Flexible Polyurethane Foam and Integral Skin Polyurethane Foam. Significantly, to date acetone has not been added to EPA's SNAP lists as a blowing agent for any type of rigid thermosetting insulation foam.

The foregoing is mentioned to highlight further the fact that, while acetone is frequently mentioned as a blowing agent, in the field of thermosetting rigid foam insulation it has heretofore not been successful.

The apparent inability to utilize acetone as a blowing agent for a commercial product is not surprising. In this regard, there are formidable problems in using acetone in the field of thermosetting rigid foam. As a first problem, acetone has a much higher boiling point, at 56.5° C. (133.7° F.), than most expansion agents used in rigid foam. As a second problem, acetone is a solvent for polyurethane foams. These two problems add up to a strong tendency to shrink closed-cell foams. This action is best described in U.S. Pat. No. 5,336,696 to Ashida, Example 7, column 9, lines 61-63: “All foams had cracks. At over 50 mole percent acetone the resulting foams had large cracks, and density determination was difficult.”

The person skilled in the art of rigid closed-cell polyurethane foam would predict that if they tried acetone as the major, or sole, blowing agent, the foam would shrink badly and have cracks. When used as the sole blowing agent, that is in fact what happens.

What is needed, therefore, and an object of the present invention, is a technique for using acetone as a meaningful and commercially viable blowing agent for the rigid closed-cell thermal insulation foam industry.

An advantage of the present invention is a low-cost insulation foam that has good dimensional stability and good insulation value.

Another advantage of the present invention is a low-cost insulation foam that has good dimensional stability and good insulation value and also does not emit prohibitive quantities of VOC emission.

### BRIEF SUMMARY

Rigid closed cell polyisocyanate-based foams are created by reacting at least one organic polyisocyanate with compounds having at least two active hydrogen atoms in the presence of at least some acetone and water used as expansion, or blowing, agents. Various additives common to rigid closed-cell foam such as cell size-controlling silicone surfactants are used to produce a thermal insulating rigid foam. Also, catalysts, flame retardant chemicals, and organic surfactants can be any of the ordinary products normally used by those experienced in the art of foam production.

### DETAILED DESCRIPTION OF THE INVENTION

In the following description, for purposes of explanation and not limitation, specific details are set forth such as particular compositions, techniques, etc. in order to provide a thorough understanding of the present invention. However, it will be apparent to those skilled in the art that the present invention may be practiced in other embodiments that depart from these specific details. In other instances, detailed descriptions of well known substances and methods are omitted so as not to obscure the description of the present invention with unnecessary detail.

In accordance with one aspect of the present invention, rigid closed cell polyisocyanate-based foams are created by reacting at least one organic polyisocyanate with compounds having at least two active hydrogen atoms in the presence of at least some acetone and water utilized as blowing agents. Various common additives such as catalysts, cell size-controlling silicone surfactants, flame retardant chemicals, and organic surfactants can be any of the ordinary products normally used by those experienced in the art of foam production. Acetone by itself normally makes a poor expansion (blowing) agent because it has a boiling point too high to provide the expansion needed to make a low density foam. The foam can become too solid at 56.5° C. (133.7° F.) which is about the temperature at which acetone begins to convert to a gas and expand. The importance of timing the rate of expansion with the rate of polymer hardening was taught in U.S. Pat. Nos. 5,252,625, 5,254,600, and 5,294,647 all incorporated herein by reference in their entirety.

The use of acetone and water in the foam-making techniques of the present invention is particularly advantageous for reducing the amount of a hydrocarbon expansion agent that otherwise might be used. Such hydrocarbon expansion agent can be, for example, one or more of Exxsol Blowing Agents or Saturated Light Hydrocarbons C₃-C₆. The Saturated Light Hydrocarbons C₃-C₆ include propane, isobutane, n-butane, isopentane, n-pentane, cyclopentane, and the various isomers of hexane. Use of the acetone and water as an expansion agent serves to limit the amount of Volatile Organic Compounds (VOC) that otherwise would be emitted due to use of the hydrocarbon expansion agent.

In reducing the amount of hydrocarbon expansion agent utilized, the use of acetone and water in the foam-making techniques of the present invention reduces the amount of VOC pollutant emitted from the process. Significantly, the degree of the reduction of VOC pollutant is believed to exceed the degree of reduction of use of the hydrocarbon expansion agent. In other words, if the amount of the hydrocarbon expansion agent (e.g., cyclopentane) is reduced by 20% and replaced by acetone and water, the reduction in VOC emissions is greater than 20%.

Other expansion agents, e.g., co-expansion agents, can also be added to the expansion agent mixture. The co-expansion agents can be any one of the other EPA Acceptable Substitutes, or any combination of them. While the list of EPA Acceptable Substitutes changes from time to time, the current list is: CO₂, Exxsol Blowing Agents, Saturated Light Hydrocarbons C₃-C₆, HFC-134a, HFC-152a, HFC-245fa, Water, Formic Acid, and 2-chloropropane. The preferred embodiments include a mixture of the approved compounds. It is anticipated that the US EPA will add 1,3-dioxolane and dimethoxymethane to the list of acceptable blowing agents.

With this new technology now available, it is possible to use a complex mixture of blowing agents from the list of Acceptable Substitutes. Any mixture of a sufficient urethane or polyiso foam blend ratio, and one which works well with a favorable surfactant package and a suitable catalyst package, can be utilized.

The use of acetone seems to improve the insulating k-factor. On page 6-251 of the 76^{th} Edition of the CRC “Handbook of Chemistry and Physics”, acetone gas is shown having a thermal conductivity of 11.5 mW/mK at 300° K. (27° C.). N-pentane gas at the same temperature is shown to have a value 25.2% worse than acetone gas, i.e. at 14.4 mW/mK. In actual foams (See Tables 1 and 2 hereinbelow), the acetone shows an improvement over n-pentane blown foams.

The preferred embodiments of the present invention utilize acetone at from approximately 1.0% by weight to approximately 90% by weight of the whole blowing agent amount. The most preferred embodiments utilize acetone from approximately 20% by weight to approximately 60% by weight of the inert blowing agent amount. As to the other blowing agents required, the present invention utilizes at least one hydrocarbon from the group comprising isobutane, n-butane, isopentane, n-pentane, cyclopentane; and, water, to create CO₂, as a co-blowing agent. Other embodiments of the present invention utilize at least one of the other optional co-blowing agents as found in the currently published US EPA SNAP List.

Generally speaking, with acetone as a minor blowing agent with some water (between 0.5 pphpp (parts per hundred parts polyol)) and 3.5 pphpp), the choice of other blowing agents will be a trade-off between cost and k-factor. For example, the use of n-butane as the other blowing agent is a low cost option, but utilizing cyclopentane instead of n-butane will provide a better k-factor. Other factors such as dimensional stability and compressive strength must be considered when choosing an additional blowing agent. The lower boiling point compounds and the lower molecular weight compounds must be relied upon to supply a major portion of the expansion; e.g., density reduction. They also supply the major amount of internal cell pressure that helps provide compressive strength and dimensional stability.

It is currently believed that several factors explain why use of water renders acetone feasible as an expansion agent in a foaming process. The reaction of water with isocyanate creates many small, rigid, and strong molecules such as ureas, biurets, and allophanates which build a network of rigid strength throughout the urethane and isocyanurate molecules. Also, because this reaction creates higher temperatures earlier (than does the reaction of polyols with isocyanate) in the foam forming cycle, the acetone boils early in the solid foam forming cycle. This means the acetone vapor causes expansion before the polymer hardens, thus replacing other expansion agents.

### EXAMPLES and TABLES

Table 1 shows four examples of prior art foam formulation technology, each example being in a different column in Table 1. In Table 1, the unit of the first row is parts by weight (pbw). The units of the second through eleventh (11^{th}) rows are in parts per hundred parts of polyol (pphpp). It should be understood that the foam formulation examples of all Tables herein can be in the context of conventional practice which involve both an “A-Blend” and a “B-Blend”. Typically the A-Blend, e.g., a first of two foam forming blends, comprises a multi-isocyanate functional compound, whereas the B-Blend includes a polyol. Usually the B-Blend also includes the blowing package (e.g., one or a mixture of “blowing” or “expansion” agents) and a catalyst.

Example 1 shows a typical prior art foam utilizing HCFC-141b as the only blowing agent. Example 2 shows the prior art of using cyclopentane as the sole blowing agent, whereas Example 3 shows normal pentane by itself. Example 4 utilizes the azeotrope Example 18 of U.S. Pat. No. 5,166,182 as its blowing agent.

To provide Examples 2, 3, and 4 foams with the requisite amount of heat resistance and flame spread control, a fire retardant, tri(2-chloroethyl) phosphate (hereinafter CEF) is used at fifteen (15)-parts per hundred parts of polyol (pphpp). The polyol used, Stepanpol 2412, is made containing approximately about 7.5% by weight of fire retardant tri(2-chloroisopropyl) phosphate.

The test that measures the Flame Spread Index of the foam core itself is the well-known “Steiner Tunnel”, or ASTM E-84. The USA Building Codes all require that a polyurethane type foam insulation have a Flame Spread Index of 75 or less.

The well-known Factory Mutual Calorimeter is a heat resistance test. This test is designed to measure the amount of roofing asphalt the insulation board allows to enter the fire zone. The FM Calorimeter is a large test, having many variables that make this determination difficult to obtain. Many laboratory tests have been proposed for screening small samples, but the most commonly used is called the “Large Hot Plate Test”.

This laboratory screening test, i.e., Large Hot Plate Test, measures the heat resistance characteristics of a sample. It subjects the bottom of the sample to an extremely high temperature. This test procedure requires a 12-inch by 12-inch hot plate capable of holding 1250° F. (676.7° C.) temperature. The sample used must have facers on the foam, and measure 10-inches by 10-inches. The sample thickness must be at least 1.25-inches. It is measured at the center by a height gauge to the nearest 1/1000-inch. It is weighed to the nearest 1/100-gram. The sample is centered on the hotplate, and held down by a 12-inch square 462-gram steel plate held in place by an angle-iron frame fastened to a lab stand. A temperature controller is used that gradually changes the hot plate temperature over a period of 30-minutes in 5-minute segments. The six (6) different 5-minute segments ramp the heat up as follows:

1) 150° F.<850° F over 5-minutes;

2) 850° F.<1000° F. over 5-minutes;

3) 1000° F.<1100° F. over 5-minutes;

4) 1100° F.<1175° F. over 5-minutes;

5) 1175° F.<1225° F. over 5-minutes;

6) 1225° F. <1250° F. over 5-minutes

Any significant changes to the sample during the 30-minutes is noted. The sample is carefully removed, cooled, and again weighed. The sample is again measured at the center by a height gauge.

TABLE 1

| COMPONENT | EXAMPLE 1 | EXAMPLE 2 | EXAMPLE 3 | EXAMPLE 4 |
|---|---|---|---|---|
| Stepanpol 2412 | 100.00 | 100.00 | 100.00 | 100.00 |
| CEF | 5.00 | 15.00 | 15.00 | 15.00 |
| Pelcat 9540-A | 4.80 | 4.80 | 5.00 | 6.20 |
| Pelcat 9858-A | — | 1.00 | 1.00 | 1.00 |
| Pelsil 9801 | 3.00 | 3.00 | 3.00 | 3.00 |
| Tertiary Amine | 0.20 | 0.20 | — | 0.24 |
| HCFC-141b | 33.8 | — | — | — |
| Cyclopentane | — | 30.00 | — | 17.49 |
| N-pentane | — | — | 29.50 | — |
| Acetone | — | — | — | 9.01 |
| Water | 0.75 | — | — | |
| NCO/OH | 250 | 300 | 300 | 300 |
| Foam density, lbs/ft³ | 2.13 | 1.79 | 1.64 | shrank |
| k-factor | 0.1244 | 0.1593 | 0.1663 | |
| Hot Plate Results | | | | unacceptable |
| Initial Thickness″ | 1.499″ | 1.943″ | 1.986″ | |
| Final Thickness″ | 0.753″ | 1.521″ | 1.512″ | |
| Thickness % Change | −49.77% | −21.72% | −23.87% | |
| Initial Weight, gr. | 123.35-g | 126.50-g | 122.43-g | |
| Final Weight, gr. | 68.63-g | 73.95-g | 71.96-g | |
| Weight % Change | −44.36% | −41.54% | −41.22% | |

This comparison shows that the prior art foam Example 4, which utilizes acetone but no water, shows unacceptable shrinkage.

TABLE 2 and TABLE 3 show Examples 5-9 of using acetone with water successfully to make rigid insulation foam in accordance with aspects of the present invention. Example 10 of TABLE 3, on the other hand, describes a prior art failure when using acetone with no water.

TABLE 2

| COMPONENTS | EXAMPLE 5 | EXAMPLE 6 | EXAMPLE 7 |
|---|---|---|---|
| Stepanpol | 100.00 | 100.00 | 100.00 |
| CEF | 15.00 | 15.00 | 15.00 |
| Pelcat 9540-A | 5.80 | 5.90 | 6.20 |
| Pelcat 9858-A | 1.00 | 1.00 | 1.00 |
| Pelsil 9801 | 3.00 | 3.00 | 3.00 |
| Tertiary | 0.18 | 0.22 | 0.18 |
| Water | 1.50 | 1.50 | 1.75 |
| Acetone | 12.05 | 13.00 | 12.50 |
| Cyclopentane | 14.85 | 13.00 | 12.50 |
| N-Butane | — | — | — |
| NCO/OH Index | 300 | 300 | 300 |
| Foam density, pcf | 1.81- | 1.90- | 1.95-lbs/ft³ |
| k-factor | 0.1497 | 0.1511 | 0.1498 |
| Hot Plate Results | | | |
| Initial Thickness″ | 1.545″ | 1.696″ | 1.740″ |
| Final Thickness″ | 1.260″ | 1.447″ | 1.278″ |
| Thickness Change | −18.45% | −14.68% | −26.58% |
| Initial Weight, gr. | 111.93-g | 120.96-g | 129.56-g |
| Final Weight, gr. | 70.19-g | 75.36-g | 78.20-g |
| Weight % Change | −37.29% | −37.70% | −39.64% |

TABLE 3

| | EXAMPLE 8 | EXAMPLE 9 | EXAMPLE 10 |
|---|---|---|---|
| Present | Present | Prior Art | |
| COMPONENTS | invention | invention | Failure |
| Stepanpol 2412 | 100.00 | 100.00 | 100.00 |
| CEF | 15.00 | 15.00 | 15.00 |
| Pelcat 9540-A | 10.00* | 8.00* | 4.90 |
| Pelcat 9858-A | 1.00 | 1.00 | 1.00 |
| Pelsil 9854 | 3.00 | 3.00 | 3.00 |
| Tertiary Amine | 0.50 | 0.50 | 0.18 |
| Water | 1.50 | 1.50 | |
| Acetone | 15.00 | 18.75 | 25.90 |
| Cyclopentane | — | — | — |
| N-Butane | 10.00 | 6.25 | — |
| NCO/OH Index | 300 | 300 | 300 |
| Foam density, pcf | 1.92-lbs/ft³ | 2.06-lbs/ft³ | excessive |
| | | | shrinkage |
| k-factor | 0.1563 | 0.1648 | ** |
| Hot Plate Results | | | unacceptable |
| Initial Thickness (in.) | 1.556″ | 1.493″ | ** |
| Final Thickness (in.) | 1.056″ | 1.096″ | ** |
| Thickness Change | −32.13% | −26.59% | ** |
| Initial Weight, gr. | 101.66-g | 102.69-g | ** |
| Final Weight, gr. | 62.57-g | 63.75-g | ** |
| Weight % Change | −38.45% | −37.92% | ** |

As indicated by the characters ** depicted in various rows for Example 10, data for Example 10 could not be obtained. The foam of Example 10 shrank in the bucket to 62.6% of the intended size, so that no data could be obtained.

All blends having n-butane were chilled to 25° F. prior to mixing, thus more catalyst was needed (depicted by the * symbol )

The results, e.g., TABLE 2 and TABLE 3, show that every Present Invention foam has properties at least as good as Prior Art foams.

In the course of developing the present invention, a small amount of acetone in a blowing agent mixture with hydrocarbons was noted as assisting density control. A foam cup with 30 pphpp (parts per hundred parts polyol) n-pentane obtained a 1.61 pcf (pounds per cubic feet) density. Using 27 pphpp n-pentane plus 3.0 pphpp acetone also obtained a 1.61 pef density. Because acetone has a much higher boiling point (133.7° F.) than n-pentane (95° F.), the foam with less low-boiling compound should have a higher density, but it did not. It is speculated that acetone, acting as a co-solvent, holds hydrocarbons into a polymer mixture while they expand.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is: The embodiments of the invention in which an exclusive property or privilege is claimed are defined as follows:

1. A thermosetting rigid foam which utilizes acetone and water as expansion agents.

2. The foam of claim 1, wherein the foam is a polyurethane foam.

3. The foam of claim 1, wherein the foam is a polyurethane modified polyisocyanurate foam.

4. The foam of claim 1, wherein an hydrocarbon volatile organic compound is also used as an expansion agent.

5. The foam of claim 4, wherein hydrocarbon volatile organic compound is one of an Exxsol Blowing Agent and a Saturated Light Hydrocarbon C₃-C₆ blowing agent.

6. The foam of claim 4, wherein the acetone and water are used with said hydrocarbon volatile organic compound expansion agents and at least one co-expansion agent.

7. The foam of claim 6, wherein said co-expansion agent is at least one of HFC-134a, HFC-152a, HFC-245fa, HFC-365mfc, Formic Acid, 1,3-dioxolane, dimethoxymethane, and 2-chloropropane.

8. The foam of claim 1, wherein the acetone comprises from approximately 1% (e.g. 1.0%) to approximately 90% by weight of an entire expansion agent package.

9. The foam of claim 1, The foam of claim 1, wherein the water comprises from about 0.5-pphpp up to about 3.5-pphpp.

10. A method of making a thermosetting rigid foam comprising:
(1) preparing a first of two foam forming blends using a multi-isocyanate functional compound;
(2) preparing a second of two foam forming blends by including a polyol;
(3) using expansion agents so that upon mixing the first and second foam forming blends a polymerization reaction occurs, the expansion agents including acetone and water.

11. The method of claim 10, wherein the foam is a polyurethane foam.

12. The method of claim 10, wherein the foam is a polyurethane modified polyisocyanurate foam.

13. The method of claim 10, further comprising using a hydrocarbon volatile organic compound expansion agent

14. The method of claim 13, wherein the hydrocarbon volatile organic compound expansion agent is one of an Exxsol Blowing Agent and a Saturated Light Hydrocarbon C₃-C₆ blowing agent.

15. The method of claim 10, wherein the acetone and water are used with said hydrocarbon volatile organic compound expansion agents and at least one co-expansion agent.

16. The method of claim 15, wherein said co-expansion agent is at least one of HFC-134a, HFC-152a, HFC-245fa, HFC-365mfc, Formic Acid, dimethoxymethane, 1,3-dioxolane, and 2-chloropropane.

17. The method of claim 10, wherein the acetone comprises from approximately 1% (e.g. 1.0%) to approximately 90% by weight of an entire expansion agent package.
The method of claim 8, wherein the water comprises from about 0.5-pphpp up to about 3.5-pphpp

18. A foam formed by the method of claim 10.

19. A foam formed by the method of claim 13.

20. A foam formed by the method of claim 15.
